(19) United States
(12) Patent Application Publication
(10) Pub. No.: US 2011/0019407 A1
(43) Pub. Date: Jan. 27, 2011

(54) REFLECTING COVER AND ILLUMINATION DEVICE USING THE SAME

(75) Inventors: PEI-YUAN HUNG, Chu-Nan (TW); MING-CHIN CHIEN, Chu-Nan (TW); YU-SHU CHEN, Chu-Nan (TW); CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/775,496

(22) Filed: May 7, 2010

(30) Foreign Application Priority Data
Jul. 21, 2009 (CN) 200910304604.4

(51) Int. Cl. F21V 7/00

(52) U.S. Cl. 362/235

(57) ABSTRACT

A reflecting cover includes a first reflective plate, a second reflective plate and a plurality of side reflective plates. The first reflective plate and the second reflective plate are perpendicular to the X-Z plane. The side reflective plates are perpendicular to the X-Y plane. The side reflective plates are located between the first reflective plate and the second reflective plate. The first reflective plate and the second reflective plate inclined toward each other. A plurality of LEDs is received in the reflecting cover and adjacent to the first reflective plate and the second reflective plate. A part of the emission of the LEDs is blocked and reflected by the first reflective plate and the second reflective plate and portions of the side reflective plates adjacent to the first and second reflective plates.

### BACKGROUND

1. Technical Field

The disclosure relates generally to illumination, and more particularly to an illumination device utilizing a reflecting system.

2. Description of the Related Art

With the development of LED-based illumination, effective distribution of generated light is a priority. One method to obtain rectangular illumination distribution utilizes a plurality of light sources with determined light emitting angles. The requisite device is, however, bulky and expensive. In a second method, a specific lens array is utilized adjusting the light emission angle. However, such a lens array is very expensive. Further, when the light is transmitted through the lens array, much light energy is lost. Thus, what is called for is an illumination device utilizing a reflecting system that can alleviate the limitations described.

### BRIEF DESCRIPTION OF THE DRAWINGS

FIG. 1 is a perspective view of a reflecting cover in accordance with a first embodiment of the disclosure.

FIG. 2 is a top view of the reflecting cover in FIG. 1.

FIG. 3 is a cross-section along line III-III of the reflecting cover in FIG. 1.

FIG. 4 is a perspective view of a reflecting cover in accordance with a second embodiment of the disclosure.

FIG. 5 is a top view of the reflecting cover in FIG. 1.

FIG. 6 is a cross-section along line VI-VI of the reflecting cover in FIG. 4.

FIG. 7 is a perspective view of a reflecting cover in accordance with a third embodiment of the disclosure.

FIG. 8 is a top view of the reflecting cover in FIG. 7.

FIG. 9 is a cross-section along line IX-IX of the reflecting cover in FIG. 7.

FIG. 10 is an exploded view of an illumination device in accordance with a fourth embodiment of the disclosure.

FIG. 11 is an illumination distribution curve of the illumination device in FIG. 10.

FIG. 12 is an illumination distribution map of the illumination device in FIG. 10.

### DETAILED DESCRIPTION

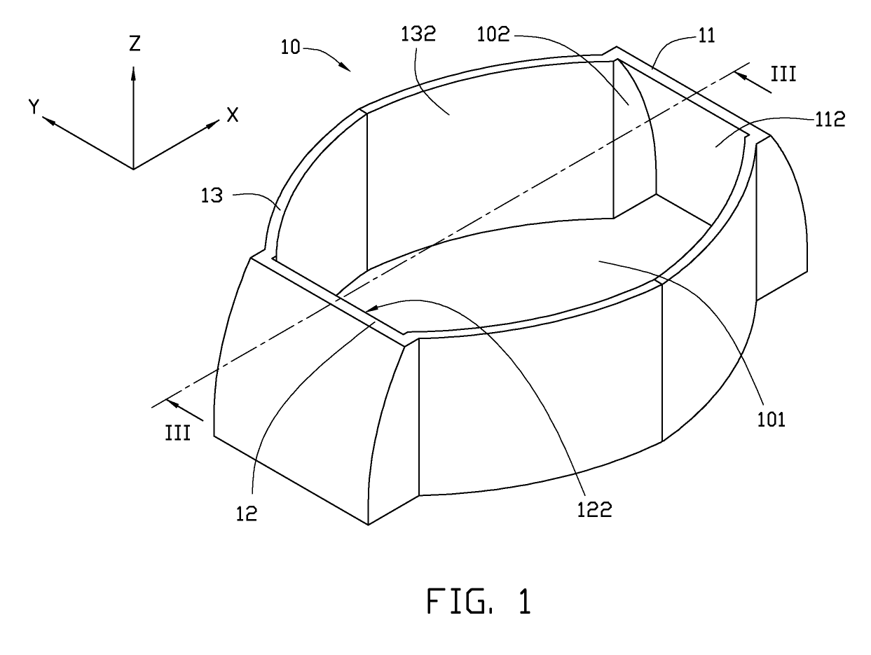

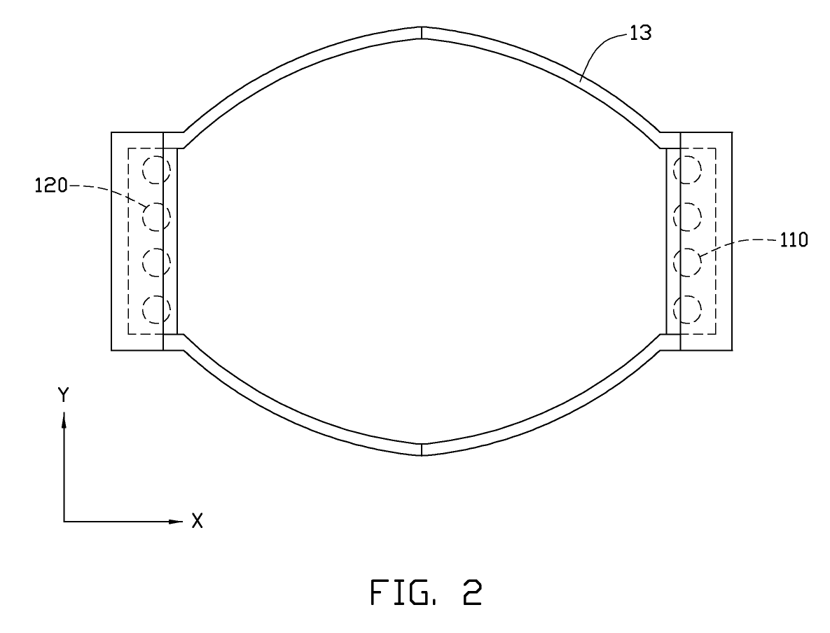

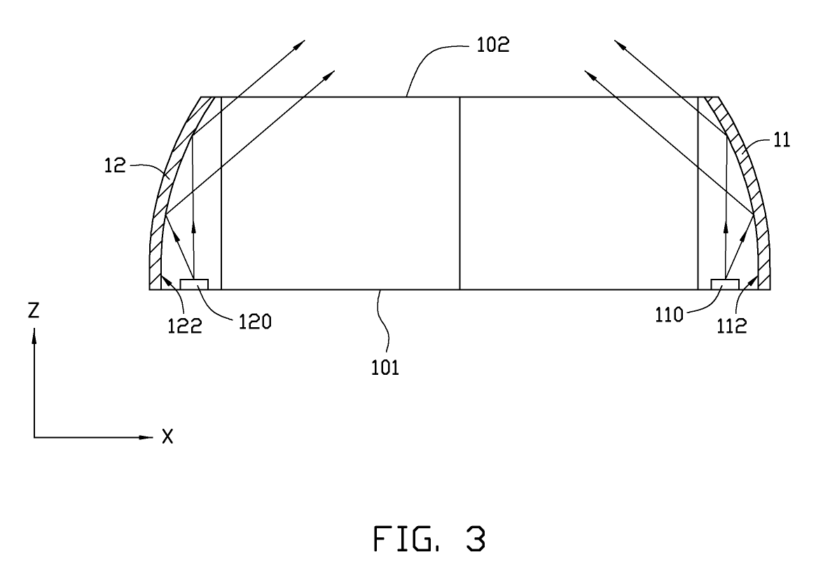

Referring to FIG. 1, FIG. 2 and FIG. 3, a reflecting cover 10 in accordance with a first embodiment of the disclosure includes a first reflective plate 11, a second reflective plate 12 and a plurality of side reflective plates 13.

The first reflective plate 11 and the second reflective plate 12 are curved plates. The first reflective plate 11 and the second reflective plate 12 are perpendicular to the X-Z plane. The first reflective plate 11 is opposite to the second reflective plate 12. The first reflective plate 11 and the second reflective plate 12 are inclined upwardly toward each other. The side reflective plates 13 are curved plates, perpendicular to the X-Y plane.

The inner surface 112 of the first reflective plate 11, the inner surface 122 of the second reflective plate 12 and the inner surfaces 132 of the side reflective plates are coated with reflective coatings. The reflecting cover 10 includes a first opening 101 and a second opening 102. The first opening 101 is larger than the second opening 102 and located below the second opening 102. A plurality of light emitting diodes (LEDs) 110, 120 are received in the first opening 101. The LEDs 110, 120 are located adjacent to the first and second reflective plates 11, 12, respectively.

A part of emissions of the LEDs 110, 120 is blocked and reflected by the first reflective plate 11 and the second reflective plate 12. Another part of the emissions of the LEDs 110, 120 is blocked and reflected by portions of the side reflective plates 13 adjacent to the first and second reflective plates 11, 12.

The first reflective plate 11 and the second reflective plate 12 are configured for reflecting the light from the LEDs 110, 120 to increase the illumination distribution along the X-axis. The side reflective plates 13 are configured for reflecting the light from the LEDs 110, 120 to increase the illumination distribution along the Y-axis. Thus the illumination distribution of the LEDs 110, 120 through the reflecting cover 10 is rectangular.

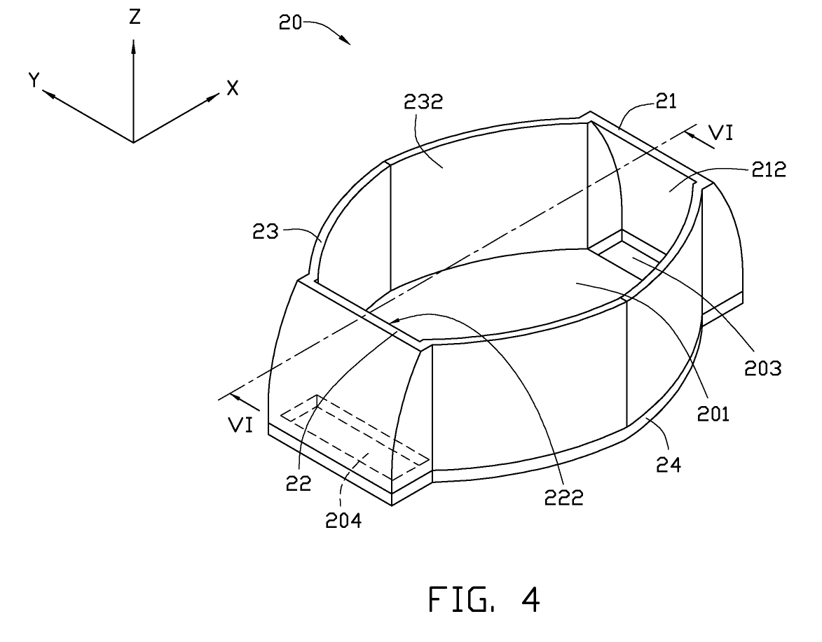

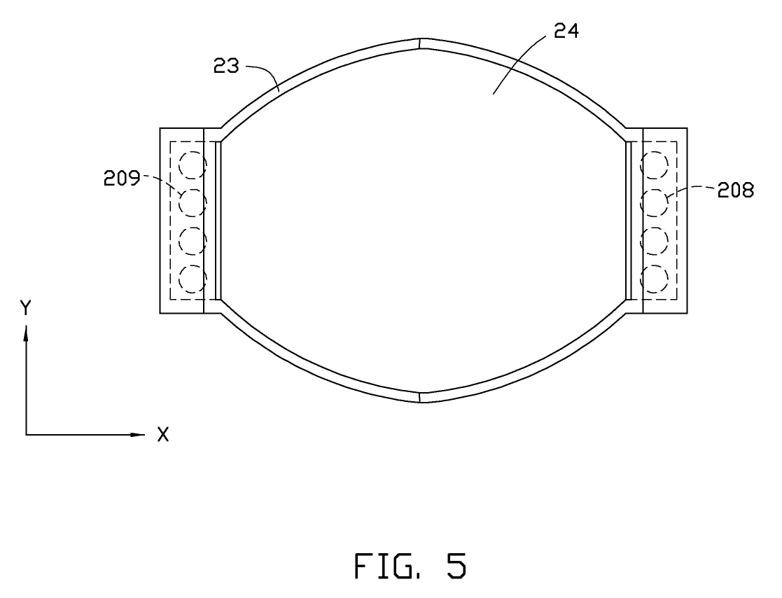

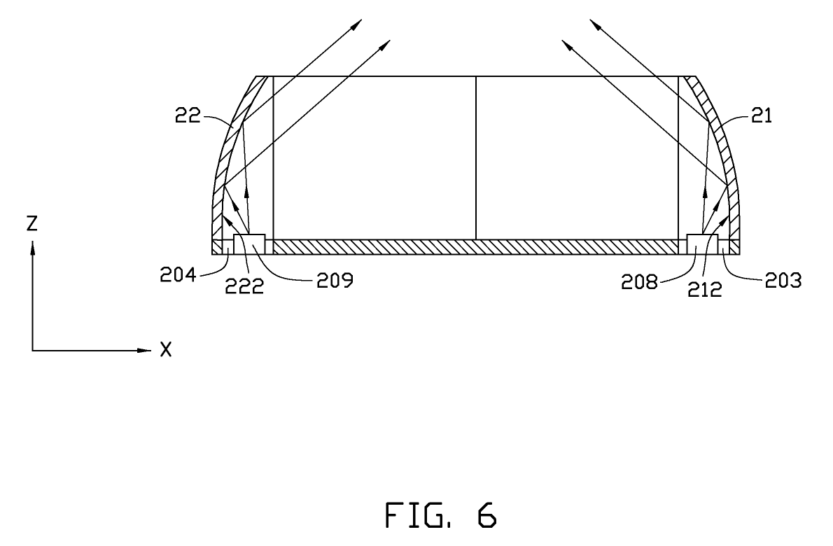

Referring to FIG. 4, FIG. 5 and FIG. 6, a reflecting cover 20 in accordance with a second embodiment of the disclosure includes a reflective plate 21, a second reflective plate 22, a plurality of side reflective plates 23 and a substrate 24.

The first reflective plate 21 and the second reflective plate 22 are curved plates. The first reflective plate 21 and the second reflective plate 22 are perpendicular to the X-Z plane. The first reflective plate 21 is opposite to the second reflective plate 22. The first reflective plate 21 and the second reflective plate 22 are inclined upwardly toward each other. The inner surface 212 of the first reflective plate 21, the inner surface 222 of the second reflective plate 22 and the inner surfaces 232 of the side reflective plates 23 are coated with reflective coatings.

The first reflective plate 21, the second reflective plate 22 and the side reflective plates 23 are mounted on the substrate 24. The substrate 24 is parallel to the X-Y plane, received in a first opening 201 of the reflecting cover 20. A first through hole 203 is defined in substrate 24, adjacent to the first reflective plate 21. A second through hole 204 is defined in the substrate 24, adjacent to the second reflecting plate 22. The first through hole 203 and the second through hole 204 are configured for receiving the LEDs 208, 209 therein. A part of emissions of the LEDs 208, 209 is blocked and reflected by the first reflective plate 21 and the second reflective plate 22.

Another part of the emissions of the LEDs 208, 209 is blocked and reflected by portions of the side reflective plates 23 adjacent to the first and second reflective plates 21, 22.

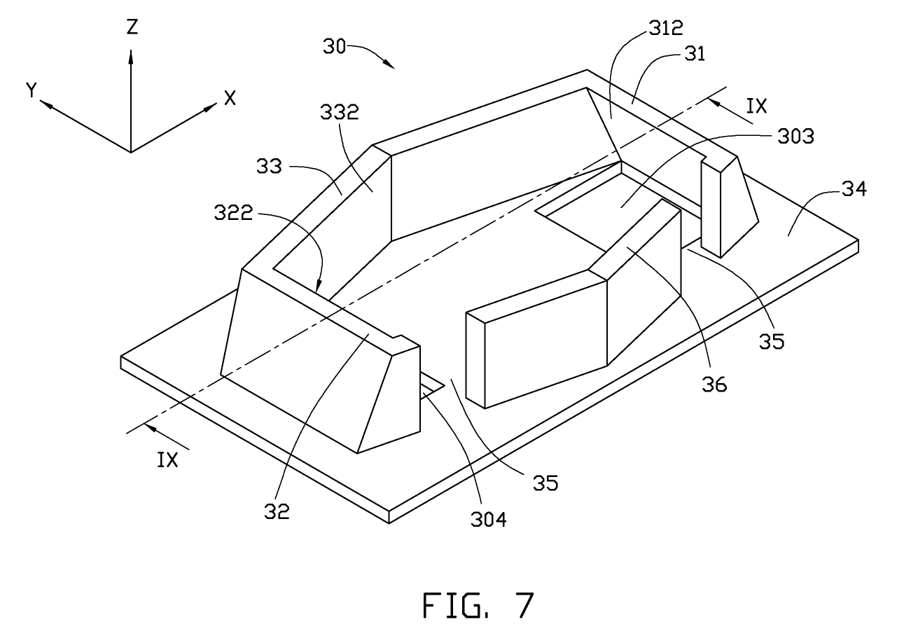

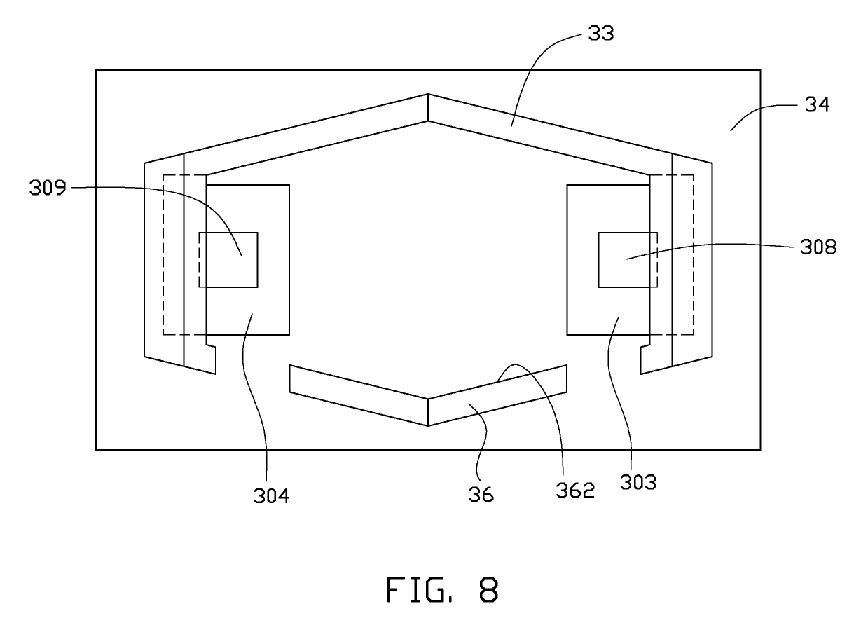

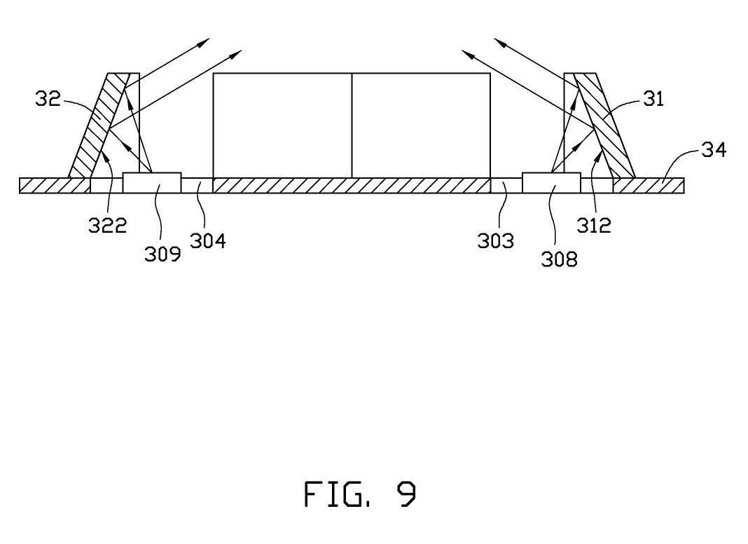

Referring to FIG. 7, FIG. 8 and FIG. 9, a reflecting cover 30 in accordance with a third embodiment of the disclosure includes a first reflective plate 31, a second reflective plate 32, a plurality of first side reflective plates 33, a plurality of second side reflective plates 36 and a substrate 34.

The first reflective plate 31, the second reflective plate 32, the first side reflective plates 33 and the second side reflective plates 36 are mounted on the substrate 34. The substrate 34 is parallel to the X-Y plane. The first reflective plate 31 and the second reflective plate 32 are perpendicular to the X-Z plane. The first reflective plates 31 and the second reflective plate 32 are inclined upwardly toward each other. The inner surface 312 of the first reflective plate 31, the inner surface 322 of the second reflective plate 32, the inner surfaces 332 of the first side reflective plates 33 and the inner surfaces 362 of the second side reflective plates 36 are coated with reflective coatings.

The first side reflective plates 33 and the second side reflective plates 36 are perpendicular to the X-Y plane. The first side reflective plates 34 and the second side reflective plates 36 are located between the first reflective plate 31 and the second reflective plate 32. Two gaps 35 are defined in the reflecting cover 30 at two opposite ends of the second side reflective plate 36.

A first through hole 303 and a second through hole 304 are defined in the substrate 34, adjacent to the first reflective plate 31 and the second reflective plate 32 respectively, and configured for receiving the LEDs 308, 309 therein. Thus, a part of emissions of the LEDs 308, 309 is blocked and reflected by the first reflective plate 31 and the second reflective plate 32. Another part of the emissions of the LEDs 308, 309 is blocked and reflected by portions of the first and second side reflective plates 33, 36 adjacent to the first and second reflective plates 31, 32.

The first reflective plate 31 and the second reflective plate 32 are configured for reflecting the light from the LEDs 308, 309 to increase the illumination distribution along the X-axis. The first side reflective plates 33, the second side reflective plates 36 are configured for increasing the illumination distribution along the Y-axis. The gaps 35 are configured for finely adjusting the illumination distribution of the LEDs 308, 309.

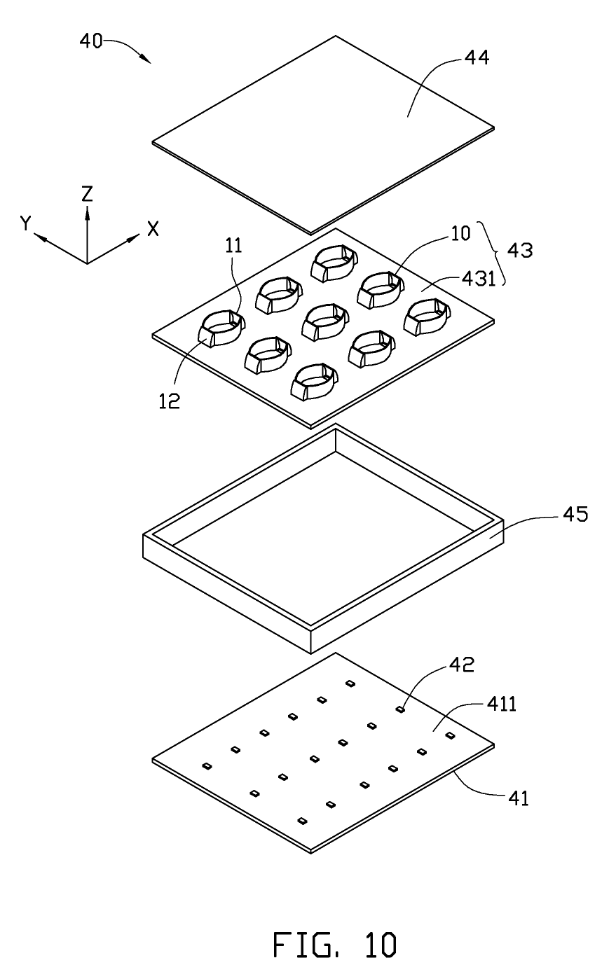

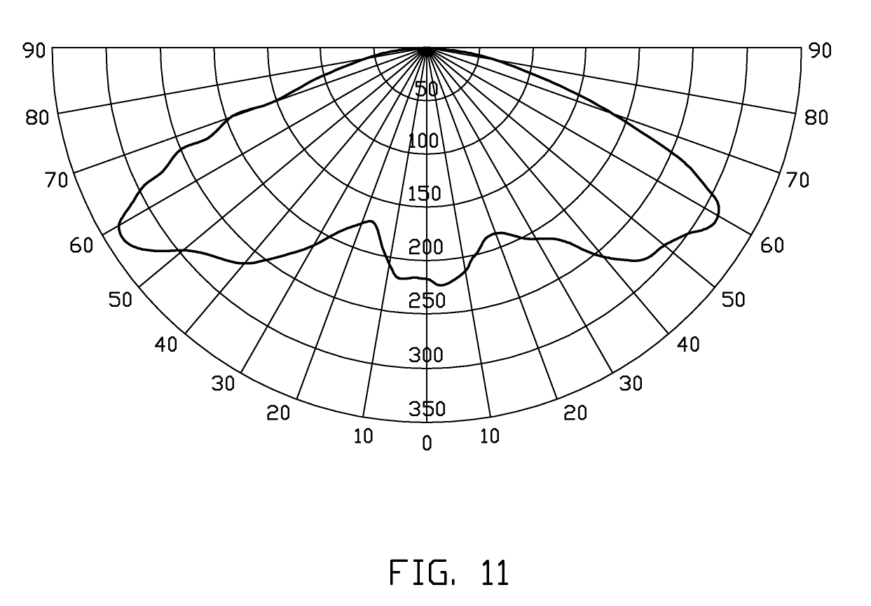

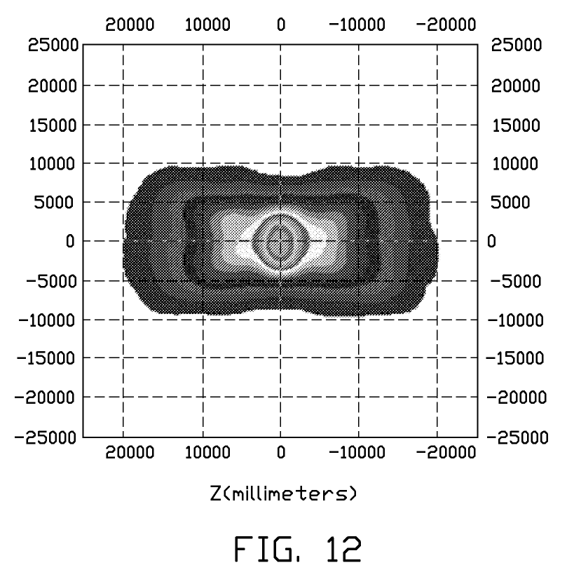

Referring to FIG. 10, FIG. 11 and FIG. 12, an illumination device 40 in accordance with a fourth embodiment of the disclosure includes a substrate 41, a plurality of LEDs 42, a reflecting module 43, a transparent plate 44 and a mounting shell 45.

The LEDs 42 are mounted on one surface 411 of the substrate 41 in matrix array. The LEDs 42 are electrically connected to the substrate 41. The substrate 41 is electrically connected to a peripheral power supply (not shown).

The reflecting module 43 includes a substrate 431 and a plurality of reflecting covers 10 as shown in the first embodiment. The reflecting covers 10 are mounted on the substrate 431 in matrix array. Each reflecting cover 10 is configured for receiving corresponding two of the LEDs 42 on the substrate 41.

The transparent plate 44 is mounted on the reflecting module 43 and opposite to a surface 411 of the substrate 41. The transparent plate 44 is a lens array, configured for uniformly transmitting the light from LEDs 42 out.

The mounting shell 45 is configured for receiving the substrate 41, the LEDs 42, the reflecting module 43 and the transparent plate 44 therein.

FIG. 11 is an illumination distribution curve of the illumination device 40. FIG. 12 is an illumination distribution map of the illumination device 40.

The structures of the reflecting cover 10, 20, 30, while simple and easily manufactured, provides rectangular illumination distribution. Production costs of illumination device utilizing these reflecting covers 10, 20, 30 decreases accordingly.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reflecting cover located in an X-Y-Z coordinate having an X-Z plane, X-Y plane and Y-Z plane which are perpendicular to each other, comprising:
a first reflective plate perpendicular to the X-Z plane;
a second reflective plate perpendicular to the X-Z plane and opposite to the first reflective plate; and
a plurality of side reflective plates perpendicular to the X-Y plane and located between the first reflective plate and the second reflective plate, the first reflective plate and the second reflective plate inclined toward each other to define a first opening of the reflecting cover with the side reflective plates, a second opening being surrounded by the first, second reflective plates and the side reflective plates, the second opening being opposite to the first opening and larger than the first opening, a plurality of LEDs received in the second opening of the reflecting cover and located adjacent to the first and second reflective plates, a part of emissions of the LEDs being blocked and reflected by the first reflective plate and the second reflective plate and another part of the emissions of the LEDs being blocked and reflected by portions of the side reflective plates adjacent to the first and second reflective plates.

2. The reflecting cover as claimed in claim 1, wherein the first reflective plate and the second reflective plate are curved plates.

3. The reflecting cover as claimed in claim 1, wherein the first reflective plate and the second reflective plate are inclined plates.

4. The reflecting cover as claimed in claim 1, wherein the side reflective plates are curved plates.

5. The reflecting cover as claimed in claim 1, wherein the reflecting cover comprises a substrate received in the second opening, the first reflective plate, the second reflective plate and side reflective plates connected to the substrate, a first through hole and a second through hole defined in the substrate, the first through hole and the second through hole configured for receiving the plurality of LEDs.

6. The reflecting cover as claimed in claim 5, wherein at least one gap is defined in the reflecting cover, the at least one gap configured for finely adjusting the illumination distribution of the LEDs.

7. An illumination device located in an X-Y-Z coordinate having an X-Z plane, X-Y plane and Y-Z plane which are perpendicular to each other, comprising:
a substrate;
a plurality of LEDs mounted on the substrate; and
a reflecting module comprising a plurality of reflecting covers, each of the reflecting covers comprising a first reflective plate, a second reflective plate and a plurality of side reflective plates, the first reflective plate and the second reflective plate perpendicular to the X-Z plane and inclined upwardly toward each other, the side reflective plates perpendicular to the X-Y plane and each interconnecting corresponding ends of the first and second reflective plates, the reflecting covers configured for receiving the LEDs in which at least one of the LEDs is received in a bottom of a corresponding reflecting cover and located adjacent to one of the first and second reflective plates of the corresponding reflecting cover.

8. The illumination device as claimed in claim 1, wherein the reflecting covers are located in matrix array.

9. The illumination device as claimed in claim 7 further comprising a mounting shell for receiving the substrate and the reflecting module therein.

10. The illumination device as claimed in claim 9 further comprising a transparent plate, the transparent plate mounted on the mounting shell for enveloping the reflecting module, the transparent plate being opposite to the substrate.

11. The illumination device as claimed in claim 7, wherein the first reflective plate and the second reflective plate are curved plates.

12. The illumination device as claimed in claim 7, wherein the first reflective plate and the second reflective plate are inclined plates.

13. The illumination device as claimed in claim 7, wherein the side reflective plates of each of the reflecting covers are curved plates.

14. The illumination device as claimed in claim 7, wherein each of the reflecting covers further comprises a substrate at a bottom thereof, the first reflective plate, the second reflective plate and the side reflective plates connected to the substrate, a first through hole defined in the substrate and adjacent to the first reflective plate and receiving at least one of the LEDs, a second through hole defined in the substrate and adjacent to the second reflective plate and receiving at least another one the LEDs, a part of emissions of the at least one and the at least another one of the LEDs being blocked and reflected by the first reflective plate and the second reflective plate.

15. The illumination device as claimed in claim 14, wherein at least one gap is defined in the each of the reflecting covers, the at least one gap configured for finely adjusting the illumination distribution of the LEDs.

16. The illumination device as claimed in claim 14, wherein another part of the emissions of the at least one and the at least another one of the LEDs is blocked and reflected by portions of the side reflective plates adjacent to the first and second reflective plates.
